(19) United States
(12) Patent Application Publication
(10) Pub. No.: US 2005/0029872 A1
(43) Pub. Date: Feb. 10, 2005

(54) Universal power supply

(76) Inventors: Kenneth S. Ehrman, Upper Saddle River, NJ (US); Jeffrey M. Jagid, Closter, NJ (US); Michael L. Ehrman, New York, NY (US); John Orris, Norwalk, CT (US)

Correspondence Address: JENKENS & GILCHRIST, A PROFESSIONAL CORPORATION;Andre M. Szuwalski, Suite 3200, 1445 Ross Avenue, Dallas, TX, 75202, US

(21) Appl. No.: 10/782,573

(22) Filed: Feb. 18, 2004

Related U.S. Application Data
(60) Provisional application No. 60/493,621, filed on Aug. 8, 2003.

(51) Int. Cl. H02J 1/00

(52) U.S. Cl. 307/11

(57) ABSTRACT

A power supply circuit receives an input voltage. The circuit includes a selectively actuated boost converter that is coupled to receive the input voltage. The selectively actuated boost converter operates to selectively boost the input voltage if the input voltage is less than a certain threshold. Otherwise, no voltage boost is needed. A forward converter circuit converts the input/boost voltage to a plurality of regulated output voltages.

### PRIORITY CLAIM

The present application claims priority from U.S. Provisional Application for Patent No. 60/493,621 filed Aug. 8, 2003, the disclosure of which is hereby incorporated by reference.

### BACKGROUND OF THE INVENTION

1. Technical Field of the Invention

The present invention relates to power supplies and more specifically to power supplies capable of operation over a wide range of input voltages and which are capable of outputting multiple different regulated output voltages. The invention is advantageously applicable to, but not limited to, power supplies installed in internal combustion or battery powered vehicles to supply power to on-vehicle electronic and/or computer devices.

2. Description of Related Art

Modular vehicle monitoring and control systems are well known in the art. An example of such a system is sold by I.D. Systems, Inc. of Hackensack, N.J. These systems provide wireless solutions for tracking and managing enterprise assets (such as material handling vehicles (fork lifts, loaders, and the like), aircraft ground support equipment (tow trucks, baggage handlers, fueling trucks, and the like), rental cars, railroad cars, and people). Using RF (radio frequency) hardware and a supporting software system, automated, intelligent and cost-effective monitoring and analysis of these enterprise assets can be provided in real time. For example, an embedded computer can monitor and control an industrial vehicle, and further communicate wirelessly with a fleet management system. Such a fleet management system provides numerous benefits, most notably in the areas of safety, cost reduction, accountability and damage reduction, and fleet/operational optimization.

In these systems, key hardware components of the system (electronic devices such as processors, controllers, RF equipment, and the like) must be installed in the mobile asset itself. This raises the issue of how these hardware components are to be powered. This is not a trivial issue to be resolved. First, the mobile asset hardware is installable in a variety of different vehicle types which possess a variety of possible operating supply voltages. For example, when installed in a gas engine powered vehicle (like a truck or car), the mobile asset has a 12V DC battery which can be used to provide a supply voltage to the hardware components. In a battery-powered vehicle (like a fork lift), however, the mobile asset has a large battery which can supply 80V DC as the supply voltage for the hardware components. These different input voltages require special attention so that proper voltage levels and power are provided. Second, the hardware components themselves have differing power supply needs. For example, one component or part of a component may need 12V DC and another component or part of a component may need 5V DC. In either case, it is likely, and in fact may be critical, that the input DC voltages to the hardware components be constant, regulated and clean. This is quite difficult to achieve in the noisy mobile asset environment in which the hardware components are installed.

A common prior art solution to the foregoing problems and concerns is to design a separate power supply solution for each of several commonly found needs. For example, a power supply is designed for the gas engine installation environment to provide a regulated, clean 5V DC output for driving logic devices from a 12V input. Another power supply, however, must be designed for the battery powered vehicle installation environment, to provide the 5V DC output to the logic devices from an 80V input. In the event the hardware components require multiple voltage inputs (for example, 5V for logic devices and 12V for analog devices), the design of the power supplies becomes more complicated, or separate supplies must be provided.

A key concern over this prior art solution of uniquely designed power supplies for certain specific installations is that a user with multiple types of vehicles under their control must stock up with each of the unique power supply modules which are needed by his vehicles. Stocking and maintaining this inventory is expensive and inefficient.

Of special concern to battery powered vehicles is the issue of power conservation. When not in use or needed, the electronic devices should be shut down or forced to enter a reduced power (sleep mode) state that minimizes power drain. The power supply for the electronic devices similarly should draw minimal power at such times and should further support electronic device operation in that mode.

A need accordingly exists for a power supply that is capable of operation across a wide range of input voltages (for example, 10V to 100V DC) and is further capable of producing a plurality of regulated, clean output voltages (for example, 5V DC, 6.4V DC and 13.4V DC) for either on-board or off-board use. The power supply should further support low/reduced power operation.

### SUMMARY OF THE INVENTION

An embodiment of the present invention is a power supply that receives an input voltage. A selectively actuated boost converter is coupled to the input and operates to selectively boost the input voltage. A forward converter converts the input/boost voltage to a plurality of regulated output voltages.

In another embodiment of the present invention, a power supply circuit comprises a voltage boost circuit that selectively boosts an input voltage to a boost voltage in response to a mode selection function which activates boost if the input voltage is less than a threshold voltage and deactivates boost if the input voltage is greater than the threshold voltage. A multi-voltage output forward converter circuit receives the input/boost voltage and generates a plurality of DC output voltages therefrom.

### BRIEF DESCRIPTION OF THE DRAWINGS

A more complete understanding of the method and apparatus of the present invention may be acquired by reference to the following Detailed Description when taken in conjunction with the accompanying Drawings wherein:

FIG. 1 is a block diagram of a universal power supply board in accordance with the present invention;

FIGS. 2A-2E are circuit schematics for some portions of the universal power supply board; and

FIGS. 3A and 3B are illustrations of custom transformers used for a power supply portion of the universal power supply board.

### DETAILED DESCRIPTION OF THE DRAWINGS

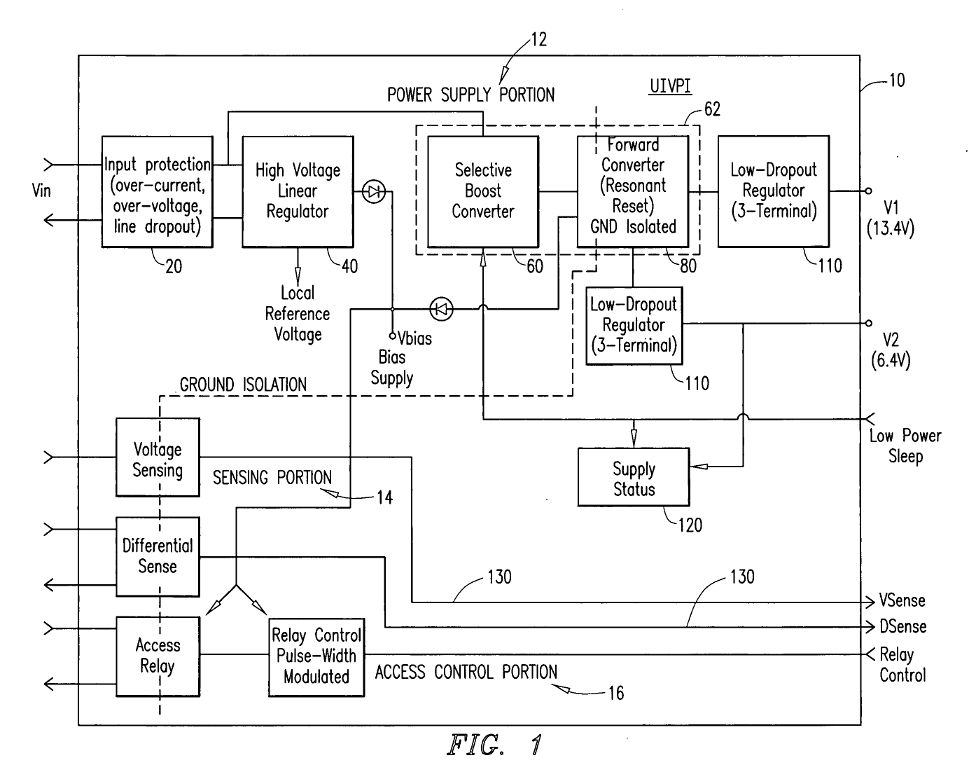

A block diagram of a universal power supply (UIVPI) board 10 is provided as FIG. 1. The overall block diagram depicts the inputs and outputs of the board 10. Generally, this board 10 performs three primary functions: industrial vehicle power interfacing with three voltage outputs (a power supply portion 12); industrial vehicle voltage monitoring with regulated outputs (a sensing portion 14); and industrial vehicle circuit interrupting for vehicle control (an access control portion 16).

In a typical example, the UIVPI board 10 is installed in the same enclosure as a digital logic board which is used to receive and interpret the monitored voltage outputs from the UIVPI board, and which sends the information to a radio frequency (RF) communicator for wireless data exchange. Such a common enclosure implementation, however, is not a requirement as the power supply portion is equally well suited for standalone implementation or integration with other components as desired. The RF communicator sends control signals to the UIVPI board 10 based on integrated decision-making capability to perform vehicle interlocking for access control (see, access control portion 16). Also, information such as vehicle usage, vehicle battery level, lift usage, engine state or gear state may be sent from the UIVPI board voltage and differential voltage sense outputs (see, sensing portion 14) into the adjoining communicator for vehicle monitoring, such as for preventative maintenance scheduling purposes. The digital logic board may also include its own voltage and differential sense as well as access control functionalities as needed.

Because the power supply portion 12 is “universal” in nature, a number of benefits accrue including:
its use limits the number of different optional power supplies for powering an on-board computing system, thus limiting production burdens, customer order burdens, inventory/stocking burdens;
its use limits the number of different optional power supplies for powering an on-board computing system, thus limiting the likelihood of erroneous installation, which typically results in failure or damage to the improper power supply, but which may result in vehicle or connected electronic device damage; and
its use simplifies the user's ability to replace or swap a system from one vehicle to another, regardless of the new vehicle's type or voltage.

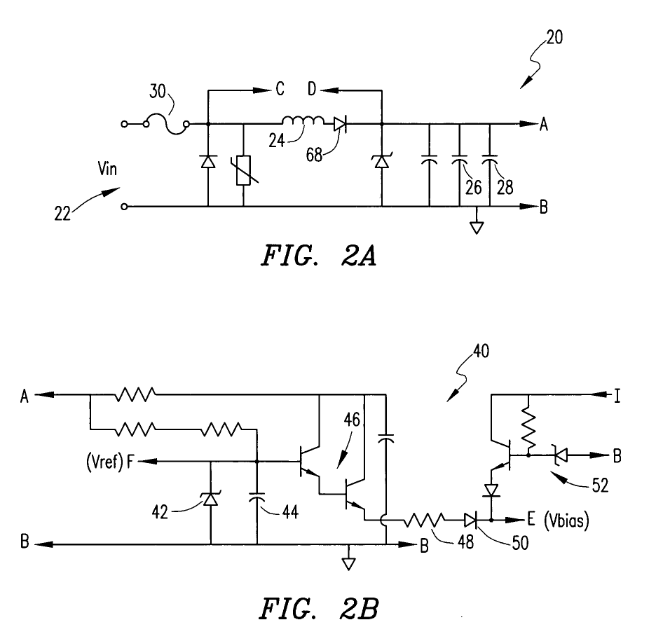

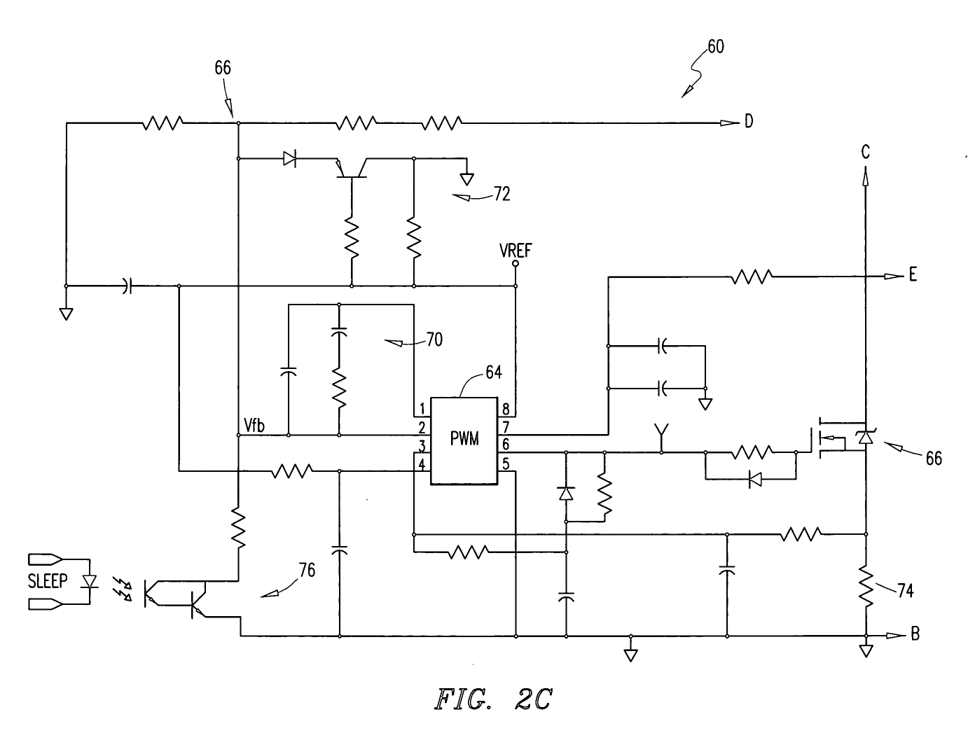

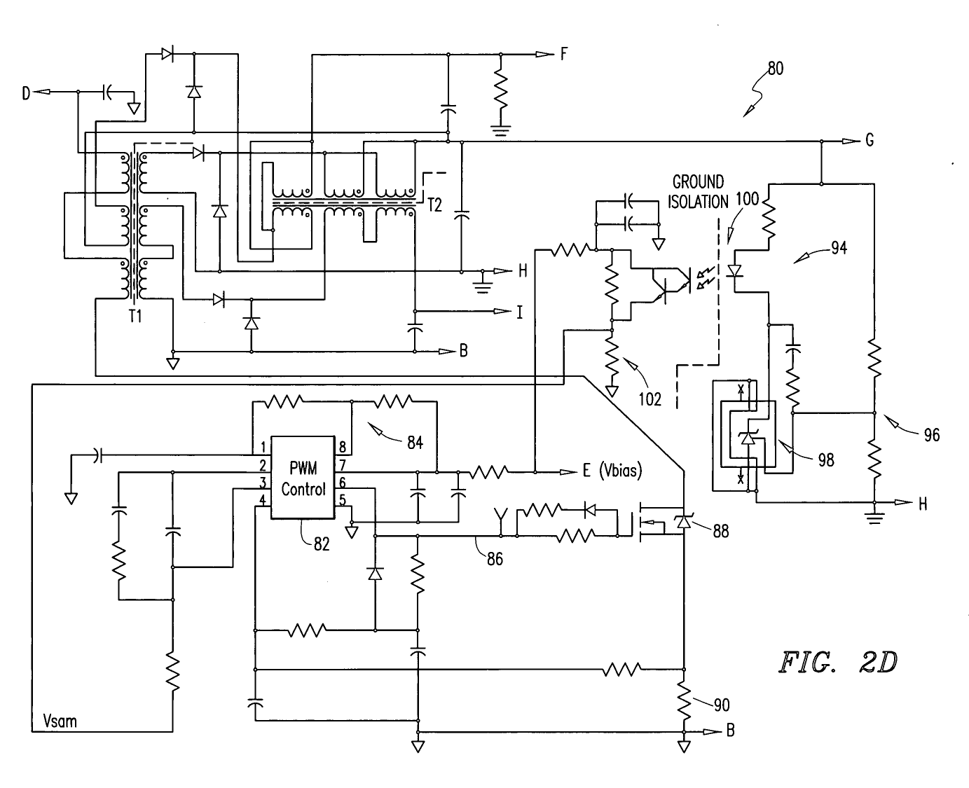

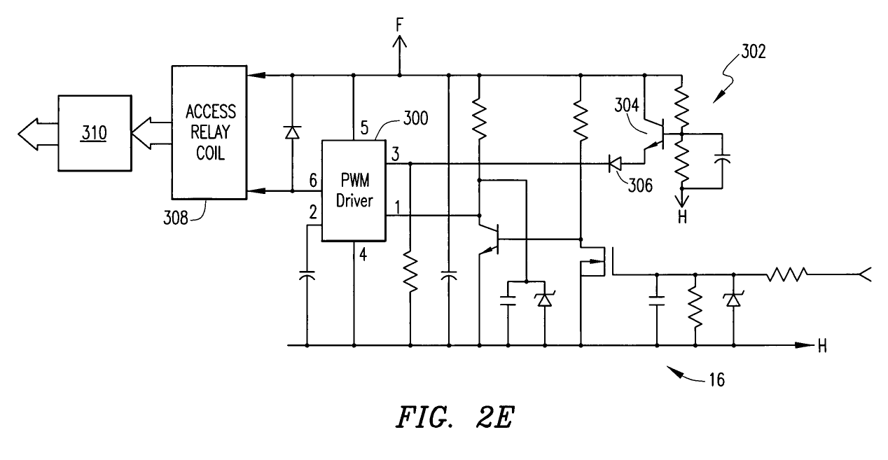

Turning first to the power supply portion 12 of the UIVPI board 10, an input protection circuit 20 (see, FIG. 2A for an exemplary schematic) is included. This input protection circuit 20 receives at its input 22 a supply voltage (Vin) which may range anywhere between about 10V DC and 100V DC (i.e., a 10:1 input ratio or better). Due to the environment in which the UIVPI board 10 operates, it must be capable of providing extreme voltage protection. Line dropout (such as during vehicle engine cranking) and over voltage spiking (such as during solenoid activation when an accelerator pedal is pressed) must not interrupt the clean output of a regulated power supply voltage for electronic device use in industrial vehicles. The input protection circuit 20 assists in addressing these design needs with respect to supporting UIVPI board 10 operation in a variety of industrial vehicles, both electric and internal combustion.

The circuit components which are critical to smoothing the input voltage Vin include an inductor 24 and capacitors 26 and 28. These components operate to store energy and thus smooth out the applied voltage (for example, in response to spikes) as well as supply stored energy when needed (for example, in response to voltage dropout). Capacitors 26 and 28 are of a relatively high value capable of storing significant amounts of charge. Input current protection is provided through fuse 30. TVS diode 32 is a high voltage (for example, 128 V) device which limits the stored voltage across the parallel connected capacitors 26 and 28.

The input protection circuit 20 includes a first output (nodes A and B) connected to a high voltage linear regulator circuit 40 (see, FIG. 2B for an exemplary schematic). The high voltage linear regulator circuit 40 addresses start-up bias supply needs for the board 10 (i.e., the generation of a suitable bias voltage (Vbias) at node E for use on the board (as Vcc, for example) when the power supply portion is powering up to receive higher voltage input). The regulator circuit further generates a reference voltage (Vref) at node F for use on board 10 (for example, in generating reference voltages for use in voltage comparator operations associated with non-power supply operational features on the board such as in the sensing portion 14). The Vbias output of the regulator circuit 40 is back biased during normal operation (i.e., after start-up is completed) in order to minimize power loss. This circuit is of standard design to provide a low cost bias supply solution. Efficiency is not of great concern here, as the supply of sufficient power on-board at start-up is the primary concern, but the circuit does advantageously dissipate little to no power when cut out.

The zener diode 42 and capacitor 44 function to provide the board local reference voltage at node F. Transistors 46 in Darlington configuration act as a current buffer and generate through resistor 48 a start-up bias current that passes through diode 50. In start-up mode operation, there is no back-bias current present at node E and thus the regulator circuit 40 functions to source necessary operational current for Vcc. However, after start-up is completed, a back-bias current (sourced from current driver 52), is made available at node E and this current causes the regulator circuit 40 to terminate current buffer operation. The regulator circuit 40 is accordingly cut out. In the event the back-bias current from the current driver 52 becomes no longer available (for example, when the UIPVI board is in “sleep mode” as later described), back bias cut out terminates and the regulator circuit 40 again functions to source the start-up bias current for Vcc generation. Voltage for operating the current driver 52 is supplied at node I from a voltage supply circuit to be described.

As discussed above, the primary power supply output of this circuit is the local reference supply (Vcc bias voltage at node E) which is used on the UIVPI board 10 during start-up and normal operation (for example, 5-15 V DC). The Vcc bias voltage is used to run the internal circuitry of the UIVPI board 10. No provision is made to run this supplied bias voltage off the board because a danger exists such that if the bias voltage were to short out, it would cause the power supply to run full time off the high voltage linear regulator circuit 40 which would get very hot at high input voltages. As also noted above, the current driver 52 in the power supply portion 12 generates the back-bias current which is used in normal operation to supply Vcc, and further additional circuits are present to generate off-board voltages. These circuits will be discussed in connection with the remaining figures of the application.

Returning for a moment back to the input protection circuit 20, it will be noted that this circuit further includes a second output (nodes C and D) which is connected to a selective boost converter circuit 60 (see, FIG. 2C for an exemplary schematic) of a universal power supply block 62. Technically, nodes C and D are not really an output. Rather, nodes C and D are connection points for the selective boost converter circuit 60 which allow the boost converter circuit and the input protection circuit 20 to advantageously, efficiently and economically share components. This helps in reducing overall cost of the board 10 and will be explained more completely later.

This selective boost converter circuit 60 is a front end of the power supply block 62 which operates as a two stage voltage converter. In operation, the front end allows the power supply block 62 to ride through low line dips (for example down to 6 V DC) and momentary power loss at the voltage input to the input protection circuit. These conditions are typical for industrial vehicles (most notably during internal combustion vehicle cranking). Additionally, the boost converter circuit is inactive when input voltage is sufficient to allow further regulation (for example, above 24 V DC). Fundamental to the unique capability of the power supply board 10 to support a wide-input supply range (for example, 10V to 100V), the boost converter circuit 60 is selectively active to permit the power supply board 10 to provide high-efficiency regulation at low input voltage levels. For input voltage levels below a selected value (such as 24 V DC), the boost converter circuit 60 is activated. During activation, the boost converter circuit 60 raises the input voltage Vin to an intermediate voltage level (for example, 27 V DC, even in the event of a low line dip or momentary power loss). This intermediate voltage can be efficiently regulated by the back end of the power supply block (to be discussed below) to supply a number of independent voltages.

The selective boost converter circuit 60 includes a pulse width modulation circuit 64 (for example, a UCC2803 PWM integrated circuit). A voltage divider 66 is connected to node D and supplies a boost voltage feedback (Vfb) to the circuit 64. A reference voltage (Vref) is also received by the circuit 64 (for example, as derived from the output of the regulator circuit 40). If Vfb>Vref, then the circuit 64 is turned off. This occurs when the voltage level at node D is sufficiently high (for example, at or above 27 V DC) to power the back end of the power supply block. If Vfb<Vref, however, the circuit 64 is turned on and the selective boost converter circuit 60 functions to boost the voltage level at node D to a sufficient level for back end operation. This voltage boosting operation is effectuated as follows: circuit 64 regulates the PWM duty cycle of a signal controlling transistor 66 in response to the Vfb/Vref comparison. When transistor 66 is on, node C is pulled to ground increasing the current flow in inductor 24 (FIG. 2A). Diode 68 prevents capacitors 26 and 28 from discharging to ground when transistor 66 is turned on. When transistor 66 then turns off, the current in the inductor 24 is dumped through diode 68 into the capacitors 26 and 28 to increase their voltage level (which appears at node D and is measured by the voltage divider 66). It can accordingly be seen how the boost converter circuit 60 and the input protection circuit 20 share components.

The boost converter circuit 60 further includes a feedback compensation circuit 70 that assists in maintaining the Vfb voltage. A voltage limiter circuit 72 is connected to the output of the voltage divider 66 to limit the Vfb voltage such that it never exceeds a threshold beyond which damage to the circuit 64 may occur. A current sensor 74 is connected to the transistor 66, with the sensor output connected to the circuit 64. Responsive to this current sensor signal, the circuit 64 decides when to turn off the transistor 66 and thus acts to limit the peak current that can be drawn from Vin (through node C and inductor 24) to a certain threshold.

To summarize, there are several key operation features of the boost converter circuit 60. It is inactive when input voltage Vin is sufficient to allow further back end regulation (for example, above 24 V DC). Fundamental to the unique capability of the power supply board 10 to support a wide-input supply range (for example, 10V to 100V), the boost converter circuit 60 is selectively active to permit the power supply to provide high-efficiency regulation at low input voltage levels. For input voltage levels below a selected value (such as 24 V DC), the boost converter circuit is activated. During activation, the boost converter circuit raises the input voltage at node D to an intermediate voltage level (for example, 27 V DC, even in the event of a low line dip or momentary power loss) which can be efficiently regulated by the back end of the power supply block 62 (to be discussed below). Critical to this operation is a switching regulator for voltage step-up operation which operates in accordance with the principles of pulse width modulation (PWM) such that the boosted output voltage is controlled or varied by modulation of duty ratio. At input voltage levels above the selected value (for example, 24 V DC), the boost converter circuit is inactive and is bypassed in essence passing the received voltage Vin from the input protection circuit through to the back end of the voltage converter operation where a plurality of discrete voltages are generated (see discussion below). Inactivating the boost converter circuit at higher voltage levels permits the supply the retain high efficiency at high input voltage levels. Critical to this operation is the voltage comparison operation as tied to the PWM operation such that the switching regulator function is terminated when the input voltage exceeds a predetermined reference voltage set by the circuit components. These unique features permit uninterrupted power to be provided to the voltage output without the use of an auxiliary battery within the power supply.

The selective boost converter circuit 60 further supports a low power sleep mode of operation for the UIVPI board 10 where the circuit, responsive to a received sleep mode signal, operates to minimize input power while keeping certain portions of the UIVPI board powered. “Sleep” mode is a power-down state in which the main features of the power supply portion of the UIVPI board 10 are shut down, including the off-board output voltages, yet access control in the remainder of the UIVPI board and an ability to resume normal operational mode for the entire board are maintained. For example, bias voltage for circuit and component operation in sleep mode is provided from the high voltage linear regulator circuit as discussed above. During sleep mode, current drain is significantly reduced to extend the duration to which a vehicle's battery can survive with an always-on access control system. The boost converter circuit 60 further includes an opto-isolator circuit 76 whose input is connected to receive the sleep mode signal. When that signal is present, the output of the opto-isolator circuit 76, which is connected to Vfb, serves to cut down the voltage boost operation that is performed by the boost converter circuit 60 in response to a low voltage Vin level (from a boosted voltage of 27 V DC to 15 V DC, for example). Reduction of boost output voltage is a key factor in lowering power supply switching losses, and accounts for an approximate 4 to 1 drop in input power drain. The opto-isolator circuit 76 is used to communicate the sleep mode signal to the boost converter circuit because of ground isolation issues to be discussed later in greater detail.

It will be recognized that in situations where the input voltage level is always in excess of some selected minimum threshold (for example, 24V DC), a boost converter circuit 60 is not required and the power supply portion may instead be configured for operation with only those circuit elements illustrated herein which provide for the conversion of an input voltage to generate a plurality of discrete voltages (i.e., the second stage of the voltage converter operation as discussed below).

The universal power supply block 62 further includes a resonant reset, ground isolated forward converter circuit 80 (see, FIG. 2D for an exemplary schematic). This circuit 80 is the back end of the power supply block 62. The forward converter circuit 80 utilizes a coupled output inductor for tight load regulation from no load to full load on any of three separate DC outputs. Also fundamental to the unique capability of supporting a wide-input supply range (for example, 10V to 100V), the forward converter circuit 80 of the back end operates in a highly efficient manner which permits the power supply to provide high-efficiency regulation either when coupled with the boost converter at low input voltage levels or when functioning alone where the boost converter is inactive at high input voltage levels.

The forward converter circuit 80 includes a pair of transformers (T1 and T2). Transformer T1 comprises an isolation transformer. It will be noted that its primary winding is connected to a first ground reference (node B). Transformer T1 further includes three secondary windings. A first one of those secondary windings is also connected to the first ground reference. The second and third secondary windings of T1 are connected to a second ground reference (node H). In this way, the forward converter circuit 80 implements a ground isolation functionality. Transformer T2 includes three inductive windings which are connected to corresponding ones of the three secondary windings of transformer T1. Thus, it will be noted that one of the windings of transformer T2 is connected to the first ground reference, while the remaining windings of T2 are connected to the second ground reference. Capacitive elements and diodes are connected between the three secondary windings of transformer T1 and the three windings of transformer T2. The combined inductance and capacitance with respect to each inter-transformer connection form an LC filter circuit. The diodes function as rectifiers. This rectifying filter accordingly functions to convert a pulsed voltage signal received on the primary winding of T1 into a DC voltage output at each of the three windings of T2. The nature of the included windings on T2 specifies the output DC voltage level. In a preferred embodiment, the three output voltages at the T2 windings are node I 15 V (first ground reference), node H 15 V (second ground reference) and node G 7.5 V (second ground reference). The node I voltage is used on-board to supply power to the current driver 52 (FIG. 2B) which supplies the back-bias current. Interleaving of transformers T1 and T2 combined with tight PCB layout assists in minimizing stray inductance in any one of the three output circuits associated with the windings of T2.

The forward converter circuit 80 further includes a pulse width modulation circuit 82 (for example, a UCC2807-3 PWM integrated circuit) and operates in a manner which is very similar to that described above for the boost converter circuit 60. The circuit 82 receives a signal (Vsam) which is a sample of the primary output voltage (node G). If Vsam>threshold set by voltage divider 84, this is indicative of the output voltage being either sufficient or perhaps too high and the circuit 82 accordingly cuts back on the duty cycle of a PWM output 86 that drives transistor 88. If Vsam<threshold, this is indicative of the output voltage being too low and the duty cycle of PWM output 86 is accordingly increased. The transistor 88 is connected in series with the primary winding of transformer T1 and node D (where the boost/intermediate voltage is present). With a decreased duty cycle (output voltage too high), the amount of energy which passes through the primary winding of T1 decreases and a corresponding decrease in output voltage at the windings of T2 is experienced. On the other hand, when the duty cycle is increased, more energy passes through the primary winding of T1 and a corresponding increase in output voltage at the windings of T2 is experienced. It is through the operation of transistor 88 that a pulsed input signal is provided to the primary winding of T1 for rectification and filtering to output DC voltages of different levels from the windings of T2.

A current sensor 90 is connected to the transistor 88, with the sensor output connected to the circuit 82. Responsive to this current sensor signal, the circuit 82 decides when to turn off the transistor 88 and thus acts to limit the peak current that can be drawn from node D (through the primary winding of T1) to a certain threshold, and thus prevent saturation.

The forward converter circuit 80 implements a resonant reset feature which eliminates the need for a discrete snubber circuit, reduces the EMI generated by the transistor 88 switch turnoff and requires no additional components to implement. The circuit components which are critical to this resonant reset feature are easily recognized by those skilled in the art from a review of the schematic and include the primary winding inductance of transformer T1 and the Coss output capacitance of forward switch transistor 88 as shown. These components operate as follows: transistor switch 88 turns off at the end of a PWM cycle. Current flowing in the primary winding inductance of T1 continues to flow into the output capacitance of transistor 88 (rather than in the FET conductive channel, which is now open). This causes the drain voltage of transistor 88 to rise. The drain voltage of transistor 88 peaks when current in the T1 primary winding finally drops to zero. The T1 primary winding inductance and Coss form a resonant LC tank which results in a sinusoidal drain voltage at turnoff. The Vds of transistor 88 continues its sinusoidal turnoff cycle as the T1 primary winding current builds in the reverse direction. This allows the transistor 88 drain voltage to drop back down to the nominal input voltage (or below) prior to the start of the next PWM cycle. Energy stored in the primary winding inductance is recycled back to the bulk input capacitor(s) 26 and 28 (see FIG. 2A) rather than being dissipated in a discrete snubber. By careful selection of the T1 primary winding inductance, transistor 88 output capacitance, power supply switching frequency and maximum duty cycle, resonant operation can be guaranteed over all line and load conditions.

The sample of the primary output voltage (for example, the 7.5 V output) is supplied to the circuit 82 by a ground isolated signal feedback circuit 94. Ground isolation is required in this instance because the primary output voltage is referenced to the second ground reference while the circuit 82 is referenced to the first ground reference. A voltage divider 96 samples the output voltage for input to a shunt regulator 98. If the sample exceeds a reference threshold, the shunt regulator pulls more current through the input of the opto-isolator 100. When this happens, more current flows in the current buffer opto-isolator output, and the voltage appearing across resistor 102 increases. This increase in voltage is fed back to the circuit 88 as Vsam.

Ground isolation (see dotted lines in all the FIGURES and see the transformers, and further note the two different ground designations at nodes B and H) is required as part of an input voltage protection system, and this feature is especially critical where the UIVPI board 10 is used in electric industrial vehicles. More specifically, it is critical that the ground for the multiple output voltages produced by the forward converter circuit (especially those voltages which are taken off-board) is separate (isolated) from the noisy ground of the input voltage which is received by the input protection circuit in order for the generated output voltages to be both clean and well regulated. The circuit components which are critical to this ground isolation feature are the transformers and opto-isolators in the schematic. Their functional operation to support isolated grounding operations is well recognized by those skilled in the art. In instances where ground isolation is not required or desired (for example, when the board 10 is installed in an internal combustion vehicle), the two ground references may simply be jumpered together.

Advantageously, the forward converter circuit provides three different DC voltage level outputs (from the three windings on T2). It is through these plural outputs that a modular and flexible functionality is provided with the power supply and the UIVPI board 10. The use of a coupled output inductor formed by the interconnection of T1 and T2 permits high-efficiency operation over the entire output load range on all three (3) DC output channels. This allows the system to drain minimal power regardless of whether the load is attached or not (this is a critical aspect of a modular vehicle system design). More specifically, the existence of a connected load will not cause a dramatic difference in current drain on the vehicle. As an exemplary illustration of the use of the power supply, for a wide range in input voltage (10V to 100V DC), the forward converter circuit can output three different clean, regulated DC voltages such as 5 V (on-board bias), 6.4V (off-board voltage) and 13.4 V (off-board voltage) DC simultaneously with high-efficiency power to each output. Some adjustment or selection in the voltages produced by the forward converter circuit is possible.

Connecting the front and back ends of the power supply block together is a key design consideration. Interaction issues between the component blocks must be addressed. To accomplish this connection, the cascaded converter impedances and PCB layout must be carefully designed in order to avoid any cross-coupling or instabilities over the complete frequency band where gain exists. It is very important that the cascading of the component blocks does not cause oscillations. Impedance selection is accomplished in the circuits using the careful placement and selection of the bulk capacitor(s) in the schematics and minimizing the input capacitance of T1 (by limiting the number of layers). It is important for the layout to isolate the control loops and power trains of each supply to prevent noise from one modulating the output(s) of the other.

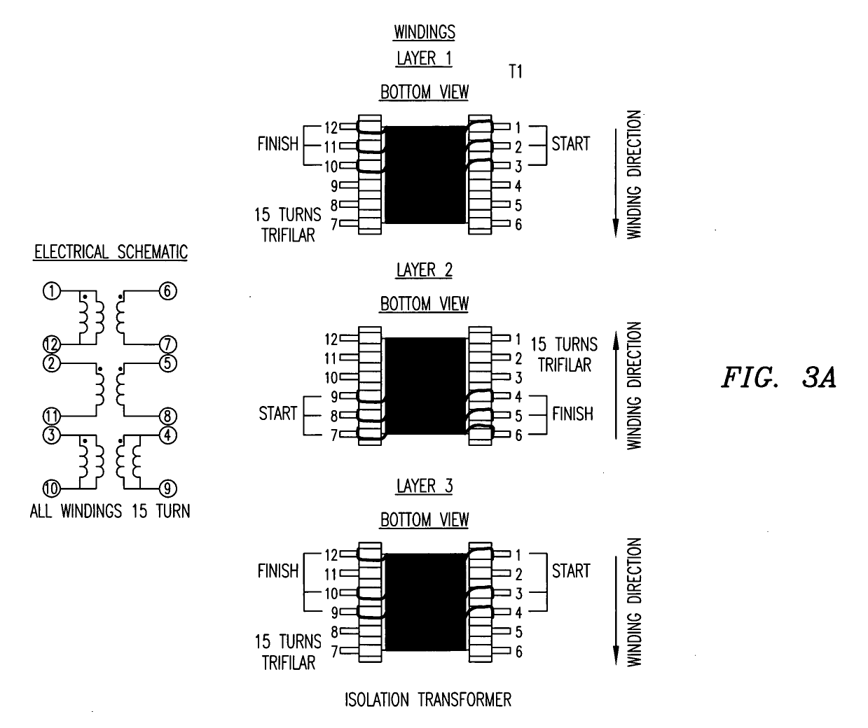

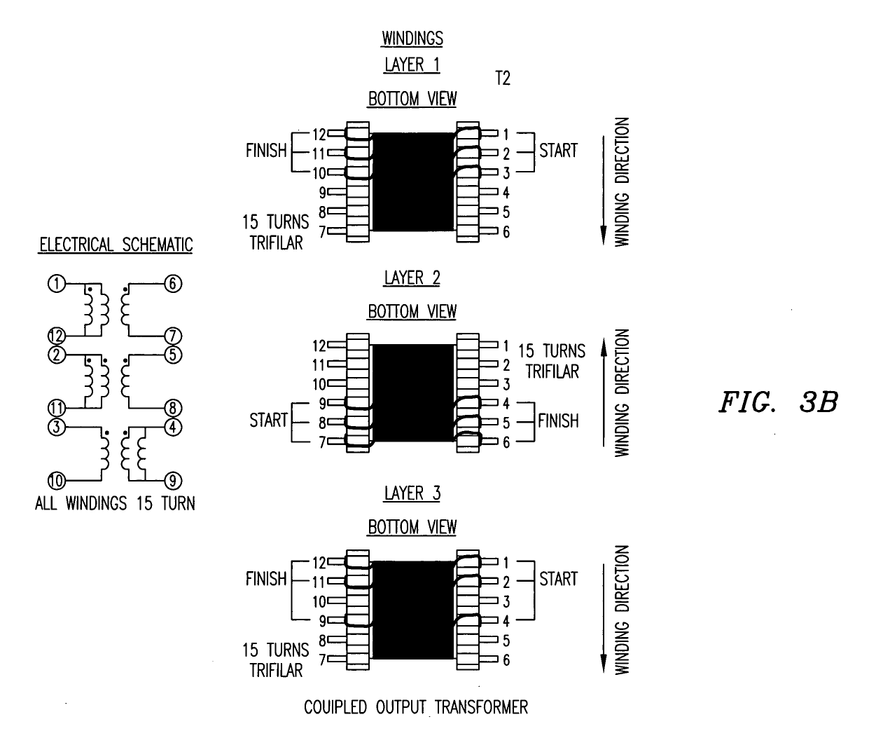

As discussed above, the forward converter circuit 80 includes a pair of transformers. The first transformer T1 is an isolation transformer that is used to support the ground isolation feature of the forward conversion functionality (as well as the resonant reset feature described above). The second transformer T2 is a coupled output inductor which is used to generate the two off-board output voltages and the single on-board (bias) voltage. The magnetics used in each of the transformers for the forward converter circuit are custom designed for this application and comprise a trifilar wound, interleaved, design (see, FIGS. 3A and 3B) which incorporates an EFD core for low profile and fairly easy winding (using a conventional bobbin where the windings utilize the full traverse of the bobbin). Interleaving is utilized to provide for improved cross-regulation. By improving cross-regulation, there is less of a chance that a change in one output voltage will result from a change in loading on the other voltage. Interleaving allows the windings of the coils to be made in parallel which results in a lower current density in copper and further allows for the use of smaller gauge wire. Notably, this smaller gauge wire enables a higher number of turns to be made per bobbin traverse, reducing core loss and limiting the required number of winding layers. As discussed above, the transformers further support the ground isolation of the power supply portion.

Instead of a coupled inductor for use in the forward converter circuit, the power supply portion could have used less expensive, off the shelf magnetic inductors. Problems with this solution, however, include very poor cross regulation, dangerously high voltages under short circuit and high input line conditions.

In the event only a single off-board voltage is being generated, the forward converter circuit need not utilize a coupled output inductor. A single inductor, of the off the shelf variety, could instead be used.

Adding additional off-board voltages can be accomplished, but requires a redesign of the magnetics (i.e., a change in both the isolation transformer and the coupled output inductor). Each output requires its own set of windings on both magnetics. Adding additional outputs further changes the physical size of the magnetics package.

An alternative to the illustrated forward converter circuit would have been to use flyback conversion. Such a circuit would, however, possess much higher peak currents and much lower efficiency at light loads.

The prior art implementation for power supplies in the fields of use for which the UIVPI board 10 is designed is to provide separate power supply units, depending on vehicle voltage, where each unit is optimized for efficiency to meet the needs of each vehicle. Alternatively, multiple supplies could be packaged into a single unit at high cost thus providing separate, but physically combined, products. Neither of these solutions is acceptable. With the power supply block 62 used in the UIVPI board 10, a universal power supply is provided which supports a high input voltage range and a high efficiency conversion to multiple output voltages. This design enables a single supply to meet the wide requirements of input voltage among all industrial vehicles and their specific input voltages. Additionally, the design meets the input voltage range with very high efficiency such -that vehicle battery life is not adversely affected by the power supply requirements.

In some scenarios, the forward converter circuit 80 produces exactly the needed output voltage. For example, the forward converter circuit can be configured to produce 5V DC for use as a reference or bias voltage on the UIVPI board 10. In other scenarios, the voltage level output from the forward converter circuit is not exactly the voltage needed (perhaps, by design), and thus further voltage regulation is necessary. To accomplish this goal, the UIVPI board 10 further includes one or more low drop-out voltage regulator circuits 110. As an example, the 15V output from the forward converter circuit may be regulated to provide a 13.4V DC output voltage for off-board applications. This 13.4V DC output voltage may, for example, be further converted elsewhere to provide a 12V supply for use by other components of the system. Any suitable, conventional low drop-out regulator circuit could be used (for example, the MIC2941ABU regulator chip from Micrel). As another example, the 7.5V output from the forward converter circuit may be regulated to provide a 6.4V DC output voltage for off-board applications. This 6.4V DC output voltage may, for example, be further converted elsewhere to provide a 5V supply for use by other components of the system. Any suitable, conventional low drop-out regulator circuit could be used (for example, the MIC29202BU regulator chip from Micrel). Any other suitable regulator circuit could be used as an alternative for those described above; what is important for efficiency considerations is to choose a regulator circuit whose input voltage is slightly higher than, but relatively close to, the desired output voltage. To support sleep mode operation, the regulator circuits are also configured to be enabled/disabled in response to the sleep mode signal.

It is possible that the power supply portion could be designed to avoid use of output linear regulators. However, these circuits advantageously reduce switching noise with the power supply (thus allowing the circuit design to meet certain FCC requirements). Additionally, having separate regulators allows the power supply to continue functioning in the event a single one of the voltage outputs is shorted.

The power supply portion 12 of the UIVPI board 10 lastly includes a supply status circuit 120 of conventional design. The supply status circuit includes a quick-status LED visual output to provide ready feedback regarding the power status of the power supply portion. The LED is off when there is either no input power or power beyond the input specification. The LED is on when proper input power is applied and the output voltage is available. The LED blinks periodically when the supply is in “sleep” mode (as discussed above) such that no output voltage is available. The circuit components which are critical to this status indication feature are a connection to the low drop-out voltage regulator output to drive the LED in active mode, and a timer chip which drives the blinking LED operation when in sleep mode.

The power supply portion of the UIVPI board supports operation from 5/10 V to 100 V DC (a 10:1 input ratio) at full load (10 W), and more specifically from 12V to 80 V DC (about 6.5:1 input ratio), along with operation to as low as 4 V DC at lower load levels (input power limited), and a power range of 0 W to 10 W, with two or more off-board voltage outputs. It is recognized that existing high-efficiency DC-to-DC converters are limited to 4:1 input ratios (for example, TI/PowerTrends, PowerOne and Pico supplies of the prior art), whereby, for example, available supplies can operate between 9 V and 36 V DC or 24 V DC to 96 VDC with about 80% efficiency to provide a single voltage output under a specific unchanging load. Due to this limitation, no single power supply of the prior art can meet the requirement for high-efficiency (required for vehicle monitoring applications due to vehicle battery drain issue) and wide operational voltage range (10 V DC to 100 V DC) required by the vast array of industrial vehicles, especially when loads can change significantly (such as when one load requires a temporary boost of current to operate). The power supply portion of the UIVPI board, however, can meet that need. Efficiency is not the primary advantage of the power supply portion, but it nonetheless advantageously operates at 75% efficiency under full load. While other supplies may be more efficient under certain conditions, none of the prior art supplies is capable of such efficiency under the full spectrum of loads and input voltages provided with the illustrated design at such efficiency levels.

To accomplish the other primary functions of the UIVPI board 10 as described above, some additional circuits are included.

For example, in a sensing portion 14 of the board, two independent voltage sense channels 130 are provided on the UIVPI board 10 for vehicle interfacing, including full differential sense to 100 V common mode on the second channel. Voltage monitoring is not a power supply requirement. It is included, however, as a separate feature on the board for use in monitoring the vehicle within which the UIVPI board 10 is installed. As part of an industrial vehicle monitoring and control system, the UIVPI board 10 supports two channels 130 of ground isolated (using opto-isolator coupling) voltage monitoring. Isolation on the voltage input is required for electric vehicles since the grounds of the power supply and the vehicle are separated for input voltage protection purposes. The two voltage inputs can be used, for example, for battery voltage monitoring and drive motor monitoring in electric vehicles, or for engine state and gear state monitoring for internal combustion vehicles. Vehicle monitoring is fundamental to a system which provides automated data collection of actual vehicle use for preventative maintenance optimization.

The UIVPI board 10 further includes a control portion 16 using an integrated relay with regulated pulse width modulated coil voltage for reduction of input power. Again, an integrated relay is not a power supply requirement. It is included, however, as a separate feature on the board for use in exercising some level of control over vehicle use and operation. As part of an industrial vehicle monitoring and control system, the UIVPI board incorporates a relay to either prevent or permit an operator's ability to drive a vehicle (“access control”). The contacts of the relay further serve as the ground isolation component of the control portion. Access control of electric vehicles typically involves a relay in series with a vehicle interlock circuit (such as a seat switch or key switch). Access control of internal combustion vehicles typically involves a relay in series with a vehicle interlock circuit (such as a seat switch or ignition switch) or a fuel-providing circuit (such as a fuel pump). A normally closed relay is designed into the circuit for safety purposes, such that a vehicle will not be shut off in case of a power supply malfunction. The use of a pulse-width modulated control signal to control the coil voltage is advantageous for current drain reduction, thus further extending vehicle battery life on a system which is always providing access control, regardless of whether the vehicle is powered on or when the power supply is in low-power mode. Vehicle control is fundamental to a system which creates accountability between a vehicle and its operator, and which automates vehicle key distribution in a facility with hundreds of operators and vehicles. This functionality is available to be controlled at all times (even when in sleep mode).

Reference is now made to FIG. 2E which illustrates a circuit for the PWM relay control circuit of the access control portion 16. It is noted that in sleep mode, the voltage powering the control portion 16 is significantly lower than in normal operation. Access relay coil voltage is maintained at nominal levels by injecting a sample of the supply voltage to the duty cycle control pin of a PWM solenoid driver integrated circuit 300 (such as the DRV101 IC manufactured by Texas Instruments). Careful selection of the resistors in voltage divider 302, in conjunction with transistor 304 and diode 306, provides the correct weighting to maintain the pulse with modulated coil drive at optimal low power operation. Access relay 308 (see also, FIG. 1) poles may be jumper selected for high voltage series operation or used separately for double pole single throw applications. This maximizes the flexibility of the design. On the output of the relay 308, a relay contact snubber 310 utilizes a full bridge diode clamp to allow the use of a volume efficient polarized capacitor. Without the full bridge diode, contact flyback voltage polarity is undefined and dependant on load position and load current direction. A non-polarized snubber capacitor would be necessary, and would require approximately 20 times the volume per unit capacitance.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A power supply, comprising:
an input receiving an input voltage;
a selectively actuated boost converter coupled to the input and operable to selectively boost the input voltage; and
a forward converter operable to convert the input voltage to a plurality of regulated output voltages.

2. The power supply of claim 1 wherein the selectively actuated boost converter includes means for comparing the input voltage to a reference voltage and boosting the input voltage above the reference voltage when the input voltage is less than the reference voltage.

3. The power supply of claim 1 wherein the plurality of output voltages are cross-regulated.

4. The power supply of claim 1 wherein the power supply produces the regulated output voltages for the input voltage which has a greater than 6.5:1 input ratio.

5. The power supply of claim 4 wherein the power supply produces the regulated output voltages across the input ratio with an efficiency in excess of about 75%.

6. The power supply of claim 1 wherein the forward converter provides ground isolation between the input voltage and the plurality of output voltages.

7. The power supply of claim 1 wherein the forward converter includes a resonant reset circuit.

8. The power supply of claim 1 wherein the forward converter utilizes a coupled output inductor to produce the plurality of output voltages.

9. The power supply of claim 8 wherein the coupled output inductor is a trifilar wound, interleaved transformer.

10. The power supply of claim 1 wherein the forward converter utilizes an isolation transformer.

11. The power supply of claim 10 wherein the isolation transformer is a trifilar wound, interleaved transformer.

12. The power supply of claim 1 further including, for each of the plurality of output voltages, a low drop-out regulator for producing a corresponding regulated output voltage.

13. The power supply of claim 1 further including an input protection circuit coupled to receive the input voltage and provide over-current, over-voltage and line drop out protection.

14. The power supply of claim 1 further including a linear regulator circuit couples to receive the input voltage and provide a start-up bias voltage.

15. The power supply of claim 1 wherein the boost converter includes a circuit for disabling boost operation in response to a sleep mode control signal.

16. The power supply of claim 15 further including, for each of the plurality of output voltages, a low drop-out regulator for producing a corresponding regulated output, each low drop-out regulator including a circuit for disabling the regulator in response to the sleep mode control signal.

17. The power supply of claim 1 further including a supply status circuit that provides a visual indication of power supply operational status.

18. The power supply of claim 17 wherein the visual indications include on, off and in sleep mode.

19. A power supply circuit, comprising:
a voltage booster including:
a boost circuit to boost an input voltage to a boost voltage; and
a mode selector that activates the boost circuit if the input voltage is less than a threshold voltage and deactivates the boost circuit if the input voltage is greater than the threshold voltage; and
a multi-voltage output forward converter circuit that receives the input/boost voltage and generates a plurality of DC output voltages therefrom.

20. The power supply circuit according to claim 19, further including a low drop-out voltage regulator circuit for each of the plurality of DC output voltages.

21. The power supply circuit according to claim 19, wherein the multi-voltage output forward converter circuit comprises:
a first transformer having a primary winding and a plurality of secondary windings;
a second transformer having a plurality of windings corresponding to the plurality of secondary windings, wherein the plurality of windings are coupled to the plurality of secondary windings where the plurality of DC output voltages are generated.

22. The power supply circuit according to claim 21 wherein the plurality of windings on the second transformer form a coupled output inductance.

23. The power supply circuit according to claim 21, wherein the multi-voltage output forward converter circuit further comprises:
a sensor to sense one of the plurality of DC output voltages;
a switching circuit coupled to the primary winding of the first transformer, the switching circuit selectively actuated to draw energy through the primary winding of the first transformer in response to the sensed output voltage.

24. The power supply circuit according to claim 23, wherein the switching circuit comprises:
a switching device connected in series with the primary winding of the first transformer; and
a pulse width modulation control circuit generating a control signal for actuating the switching device, the control signal having a variable duty cycle set responsive to the sensed output voltage.

25. The power supply circuit according to claim 21 wherein the first and second transformers have a trifilar wound interleaved design.

26. The power supply circuit according to claim 19 wherein the input voltage and at least one of the plurality of DC output voltages are ground isolated.

27. The power supply circuit according to claim 19 wherein the forward converter circuit includes a resonant reset functionality which obviates a need for a discrete snubber circuit.

28. The power supply circuit according to claim 19 wherein the plurality of DC output voltages are cross-regulated.

29. The power supply circuit according to claim 19 wherein the forward converter circuit generates the plurality of DC output voltages at regulated levels across an input voltage ratio of at least 6.5:1.

30. The power supply circuit according to claim 19 wherein the forward converter circuit generates the plurality of DC output voltages at regulated levels across an input voltage ratio of at least 10:1.

31. The power supply circuit according to claim 19 further including an input circuit that smoothes the input voltage.

32. The power supply circuit according to claim 31, wherein the input circuit includes both inductive and capacitive elements.

33. The power supply circuit according to claim 32, wherein the inductive and capacitive elements are shared elements between the input circuit to smooth the input voltage and the voltage booster to boost the input voltage to the boost voltage.

34. The power supply circuit according to claim 19, wherein the boost circuit of the voltage booster comprises a switching regulator for voltage step-up operation.

35. The power supply circuit according to claim 34, wherein the switching regulator is a pulse width modulated regulator.

36. The power supply circuit according to claim 19, wherein the mode selector implements a bypass operation to bypass the input voltage around the boost circuit when the input voltage is greater than the threshold voltage.
